(19) United States
(12) Patent Application Publication
(10) Pub. No.: US 2025/0388089 A1
(43) Pub. Date: Dec. 25, 2025

(54) ELECTRICAL BRAKING SYSTEM FOR ELECTRIFIED VEHICLE

(71) Applicant: FCA US LLC, Auburn Hills, MI (US)

(72) Inventors: Marcus Hemmye, Auburn Hills, MI (US); Evan J. Oswald, Auburn Hills, MI (US); Randy T. Gerken, Auburn Hills, MI (US); David W. Smith, Auburn Hills, MI (US); Mark A. Levine, Auburn Hills, MI (US); Keith Wasserman, Auburn Hills, MI (US); Jason C. Hedlund, Auburn Hills, MI (US)

(21) Appl. No.: 18/753,163

(22) Filed: Jun. 25, 2024

(51) Int. Cl. B60L 7/18; B60L 50/16

(52) U.S. Cl. CPC B60L 7/18; B60L 50/16; B60L 2240/423; B60L 2250/26

(57) ABSTRACT

An electrical braking system for an electrified vehicle includes a battery system, an electric motor, an electrical energy management module and a controller. The electric motor is powered by the battery system and transfers drive torque to a driveline for propulsion of the vehicle and that selectively directs regenerative power to the battery system during regenerative braking in a first mode. The electrical energy management module has a first energy recovery system that stores additional energy from the regenerative power harnessed from the electric motor in a second mode and a first energy dissipation system that dissipates additional energy from the regenerative power in a third mode. The controller receives an input from a brake pedal indicative of a braking event of the electrified vehicle and, responsive to the input, determines whether to direct the regenerative power in at least one of the first, second and third modes.

### FIELD

The present application generally relates to electrified vehicles and, more particularly, to an electrical braking system for an electrified vehicle, the electrical braking system including an energy recovery system and energy dissipation system that provide brakeless deceleration for the electrified vehicle.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes a battery pack assembly including one or more battery modules that can be charged such as by plugging into a power supply or by receiving a charging input from a vehicle component. In examples, some electrified vehicles are configured with regenerative braking systems that can convert vehicle braking energy into a charging input to the battery system during vehicle braking. In some conditions where the vehicle battery system is already sufficiently charged, it is undesirable to use regenerative braking as a charging input. If the battery system is at or close to a maximum state of charge, regenerative power needs to be accounted for in other manners. Accordingly, while such battery systems do work well in combination with regenerative braking systems for their intended purpose, there exists an opportunity for improvement in the relevant art.

### SUMMARY

According to one example aspect of the invention, an electrical braking system for an electrified vehicle includes a battery system, an electric motor, an electrical energy management module and a controller. The battery system selectively stores and delivers power. The electric motor is powered by the battery system and transfers drive torque to a driveline for propulsion of the vehicle and that selectively directs regenerative power to the battery system during regenerative braking in a first mode. The electrical energy management module has a first energy recovery system that stores additional energy from the regenerative power harnessed from the electric motor in a second mode and a first energy dissipation system that dissipates additional energy from the regenerative power harnessed from the electric motor in a third mode. The controller receives an input from a brake pedal indicative of a braking event of the electrified vehicle and, responsive to the input, determines whether to direct the regenerative power in at least one of the first, second and third modes.

In some implementations, the first energy recovery system comprises a capacitor.

In some implementations the first energy dissipation system comprises a resistor.

In other arrangements, the first energy dissipation system comprises a resistive load bank.

According to another example aspect of the invention, the electrical braking system further includes a kinetic energy management module having a second energy recovery system that stores additional energy from the braking event in a fourth mode, wherein the controller further determines whether to operate in the fourth mode.

In some implementations, the second energy recovery system includes one of a hydraulic and mechanical accumulator.

In some implementations, the second energy recovery system includes an air energy recovery system

In additional features, the kinetic energy management module includes a second energy dissipation system that dissipates additional energy from the braking event in a fifth mode, wherein the controller further determines whether to operate in the fifth mode.

In other implementations, the second energy dissipation system comprises a parking brake.

According to another example aspect of the invention, a method for operating an electrical braking system of an electrified vehicle is provided. The electrical braking system has a battery system that selectively stores and delivers power, an electric motor that is powered by the battery system and transfers drive torque to a driveline for propulsion of the electrified vehicle and that selectively directs regenerative power to the battery system during regenerative braking in a first mode, and an electrical energy management module having a first energy recovery system that stores additional energy from the regenerative power harnessed from the electric motor in a second mode and a first energy dissipation system that dissipates additional energy from the regenerative power harnessed from the electric motor in a third mode. The method includes: receiving, at a controller, a signal indicative of a vehicle braking event; determining whether to direct the regenerative power in at least one of the first, second and third modes; and directing the regenerative power based on the determined at least one of the first, second and third modes.

In additional arrangements, the first energy recovery system comprises a capacitor.

In additional features, the first energy dissipation system comprises one of a resistor and a resistive load bank.

In additional examples, the method includes providing a kinetic energy management module having a second energy recovery system that stores additional energy from the braking event in a fourth mode, wherein the controller further determines whether to operate in the fourth mode.

In examples, the second energy recovery system includes one of a hydraulic and mechanical accumulator.

In other implementations, the second energy recovery system includes an air energy recovery system.

In other features, the kinetic energy management module includes a second energy dissipation system that dissipates additional energy from the braking event in a fifth mode, wherein the controller further determines whether to operate in the fifth mode.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a regenerative braking system that incorporates a deployable regenerative system resistor according to the principles of the present application; and

FIG. 2 is an exemplary logic flow diagram of a controller that operates the electrical braking system of the present disclosure.

### DESCRIPTION

Conventional electrified vehicles typically rely on engine braking to manage vehicle speed and acceleration on road downgrades to inhibit vehicle runaway and excessive heat generation. Such systems also reduce wear on a conventional friction brake system. As is known, an electric motor or motors in an electrified vehicle can act as an electric generator when the electric motor or motors stop supplying power to the vehicle drivetrain for propulsion. In examples, the electric motor(s) can rotate backwards while converting kinetic energy from the vehicle wheels as they slow down into electricity that can be stored back in the vehicle battery. Further, in many instances a vehicle deceleration rate can be controlled solely by a regenerative braking system without using the conventional friction brake system. Examples include a vehicle motion controlled primarily by the accelerator pedal, or a zero accelerator pedal input coasting deceleration while traveling down a grade.

In an electrified vehicle, the ability of the electric drive motor(s) to provide regenerative braking requires a mechanism to use or store the power being generated by the electric motor(s) during regenerative braking. If the battery system is at or close to a maximum state of charge, regenerative power needs to be accounted for in other manners.

Accordingly, the electrical braking system of the present disclosure eliminates hydromechanical braking systems by recapturing most of the energy that was previously lost as heat in a more ecologically efficient system. Where traditional braking is done mostly by the energy wasting brake systems in internal combustion engine (ICE), battery electric vehicle (BEV) and plug-in-hybrid electric vehicle (PHEV) configurations, the electrical braking system herein recaptures all of the energy it can through regenerative means.

The electrical braking system determines when energy storage at the battery system is full, or that the energy generation rate exceeds the vehicle's standard ability to capture and convert the energy. The electrical braking system will either capture the energy in a temporary storage location, or dissipate the braking energy in a directed controllable manageable location in the vehicle. The ability to direct the decelerative energy is also an improvement over the conventional hydromechanical braking systems, resulting in a braking capability increase for the vehicle. Similar to traditional electric vehicle braking systems, the user activates regenerative braking by lifting their foot off the accelerator pedal. With the electrical braking system of the instant disclosure, by pressing the brake pedal, the electrical braking system operates the electrical energy management techniques. The electrical braking system described herein acts as the exclusive braking system in the vehicle and eliminates traditional friction brake systems.

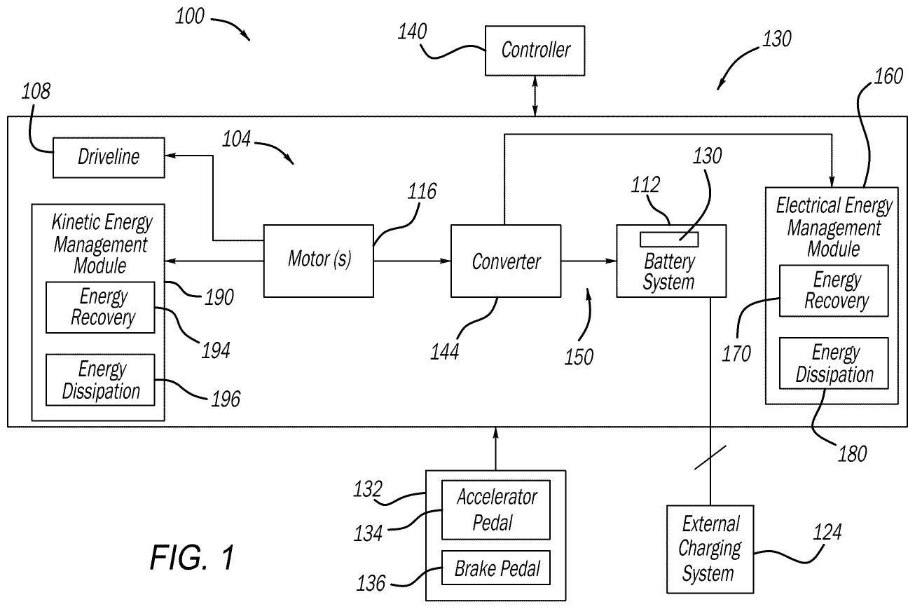

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission. The battery system 112 is selectively connectable (e.g., by the driver) to an external charging system 124 (also referred to herein as “charger 124”) for charging of the battery system 112. The battery system 112 includes at least one battery module 130. The electrified vehicle 100 includes a driver input system 132 that includes an accelerator pedal 134 that communicates an acceleration request to the controller 140 and a brake pedal 136 that communicates a brake request to the controller 140.

The electrified vehicle 100 incorporates an electrical braking system 130. The electrical braking system generally includes a controller 140 that cooperates with a converter 144. The controller 140 and converter 144 determine whether braking energy from the electric motors 116 is delivered to the battery system 112 in a traditional regenerative braking system 150, or to an electrical energy management module 160. The electrical energy management module 160 generally includes an energy recovery system 170 and energy dissipation system 180. As discussed herein, the energy recovery system 170 can include a capacitor or ultracapacitor that can store additional energy harnessed from the electric motors 116 during a braking event. The energy dissipation system 180 can include a resistor or resistive load bank configured to dissipate additional energy harnessed from the electric motors 116 during a braking event.

The electrical braking system 130 can also incorporate a kinetic energy management module 190 having a kinetic energy recovery system 194 and a kinetic energy dissipation system 196. In examples, the kinetic energy recovery system 194 can include a kinetic/hybrid air energy recovery system. In additional examples the kinetic energy recovery system 194 can additionally or alternatively include a hydraulic/mechanical accumulator. The kinetic energy dissipation system 196 can include any device that kinetically dissipates energy such as, but not limited to a parking brake.

As used herein the regenerative braking system 150 is used to encompass non-braking deceleration events in which regeneration of the battery system 112 (high or low voltage system) can occur. In examples, the regenerative braking system 150 can be configured to direct regenerative power from the motor(s) 116 to the kinetic energy management module 190. The energy dissipation system 196 can direct kinetic energy to accessory loads that can be any vehicle loads that can draw electric power from the battery system 112. Accessory loads can be an alternative method of using power in addition to routing power back to the battery system 112.

The controller 140 can determine how to direct the braking energy with the converter 144 depending on sensed operating conditions of the vehicle 100 and a charging state of the battery system 112. In examples, the controller 140 can determine that the battery system 112 is sufficiently charged such that braking energy is diverted instead to the electrical management module 160 where it can be recovered (for later use) at the energy recovery system 170, or where it can be dissipated (expelled) at the energy dissipation system 180. The controller 140 can also determine to divert braking energy to the electrical management module 160 for other reasons, such as various operating conditions, even when the battery system 112 is not fully charged.

As identified above, the regenerative power of the motor(s) 116 would generally be directed back into the battery system 112. The electrical braking system 130 can recognize when the battery system 112 does not need more regenerative power (e.g., the battery system 112 is sufficiently charged) and can divert the regenerative power to the electrical energy management module 160, and/or to the kinetic energy management module 190. In some examples, one or both of the energy recovery system 194 and the energy dissipation system 196 is sufficient to accommodate all of the diverted regenerative power. In other examples, the kinetic energy management module 190 cannot handle all of the diverted regenerative power and the electrical energy management module 160 can assist in handling the additional diverted regenerative power.

In advantages, the electrical braking system 130 can eliminate the use of traditional friction brakes and related hardware which can reduce vehicle weight, reduce system complexity, and remove environmentally harmful consumables from the system. Further advantages include the increase of regenerative capability of the vehicle as needed without the energy losses of a friction brake system. Excess energy captured by regenerative braking can be stored when energy storage of the battery system 112 is full. Excess energy captured by the regenerative braking can be easily dissipated as needed.

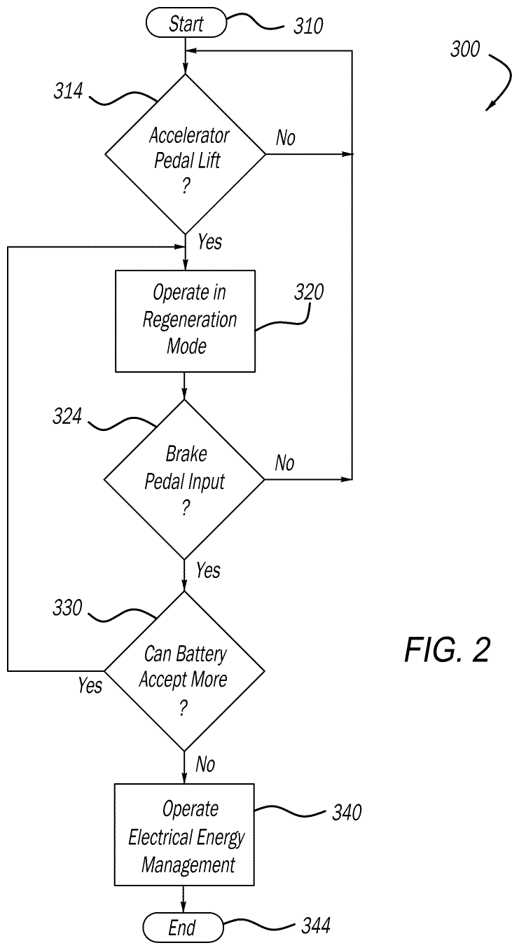

With particular reference now to FIG. 2, a flow chart 300 is shown illustrating an exemplary control methods for operating the electrical braking system 130 according to various examples of the present disclosure. Control starts at 310. At 212 control determines whether an accelerator pedal 134 has lifted (e.g., no user input). If not, control loops to 314. At 320, control operates the electric braking system 310 in regeneration mode.

At 324 control determines whether the brake pedal 136 has been depressed. If not, control loops to 314. If control determines that the brake pedal 136 has been depressed, control determines whether the battery system 112 can accept more power at 330. If the battery system 112 can accept more power, control loops to 320 and the electrical braking system 130 operates in regeneration mode.

If control determines that the battery system 112 cannot accept more power (e.g., the battery system 112 is full or otherwise cannot accept additional power input), control operates the electrical braking system 130 in an electrical energy management mode at 340. In the electrical management mode, control can determine that braking power can be delivered to at least one of the electrical energy management module 160 and the kinetic energy management module 190.

As noted above, in some instances, one or both of the energy recovery system 194 and the energy dissipation system 196 is sufficient to accommodate all of the diverted regenerative power. In other examples, the kinetic energy management module 190 cannot handle all of the diverted regenerative power and the electrical energy management module 160 can assist in handling the additional diverted regenerative power. The energy recovery system 170 of the electrical energy management module includes a capacitor or ultracapacitor that stores additional energy harnessed from the electric motors 116 during a braking event. The stored energy can be used for powering the electric motors 116 at a later time. The energy dissipation system 180 includes resistor or resistive load bank that dissipates additional energy harnessed from the electric motors 116 during a braking event. Control ends at 344. It is appreciated that control can alternatively be configured to loop back to step 314.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electrical braking system for an electrified vehicle, the electrical braking system comprising:
a battery system that selectively stores and delivers power;
an electric motor that is powered by the battery system and transfers drive torque to a driveline for propulsion of the vehicle and that selectively directs regenerative power to the battery system during regenerative braking in a first mode;
an electrical energy management module having a first energy recovery system that stores additional energy from the regenerative power harnessed from the electric motor in a second mode and a first energy dissipation system that dissipates additional energy from the regenerative power harnessed from the electric motor in a third mode; and
a controller that receives an input from a brake pedal indicative of a braking event of the electrified vehicle and, responsive to the input, determines whether to direct the regenerative power in at least one of the first, second and third modes.

2. The electrical braking system of claim 1, wherein the first energy recovery system comprises a capacitor.

3. The electrical braking system of claim 2, wherein the first energy dissipation system comprises a resistor.

4. The electrical braking system of claim 2, wherein the first energy dissipation system comprises a resistive load bank.

5. The electrical braking system of claim 1, further comprising:
a kinetic energy management module having a second energy recovery system that stores additional energy from the braking event in a fourth mode, wherein the controller further determines whether to operate in the fourth mode.

6. The electric braking system of claim 5, wherein the second energy recovery system includes one of a hydraulic and mechanical accumulator.

7. The electric braking system of claim 5, wherein the second energy recovery system includes an air energy recovery system.

8. The electric braking system of claim 5, wherein the kinetic energy management module includes a second energy dissipation system that dissipates additional energy from the braking event in a fifth mode, wherein the controller further determines whether to operate in the fifth mode.

9. The electric braking system of claim 8, wherein the second energy dissipation system comprises a parking brake.

10. A method for operating an electrical braking system of an electrified vehicle, the electrical braking system having a battery system that selectively stores and delivers power, an electric motor that is powered by the battery system and transfers drive torque to a driveline for propulsion of the electrified vehicle and that selectively directs regenerative power to the battery system during regenerative braking in a first mode, and an electrical energy management module having a first energy recovery system that stores additional energy from the regenerative power harnessed from the electric motor in a second mode and a first energy dissipation system that dissipates additional energy from the regenerative power harnessed from the electric motor in a third mode, the method comprising:
receiving, at a controller, a signal indicative of a vehicle braking event;
determining whether to direct the regenerative power in at least one of the first, second and third modes; and
directing the regenerative power based on the determined at least one of the first, second and third modes.

11. The method of claim 10, wherein the first energy recovery system comprises a capacitor.

12. The method of claim 11, wherein the first energy dissipation system comprises a resistor.

13. The method of claim 11, wherein the first energy dissipation system comprises a resistive load bank.

14. The method of claim 10, further comprising:
providing a kinetic energy management module having a second energy recovery system that stores additional energy from the braking event in a fourth mode, wherein the controller further determines whether to operate in the fourth mode.

15. The method of claim 14, wherein the second energy recovery system includes one of a hydraulic and mechanical accumulator.

16. The method of claim 14, wherein the second energy recovery system includes an air energy recovery system.

17. The method of claim 14, wherein the kinetic energy management module includes a second energy dissipation system that dissipates additional energy from the braking event in a fifth mode, wherein the controller further determines whether to operate in the fifth mode.

18. The method of claim 17, wherein the second energy dissipation system comprises a parking brake.
